(19) United States
(12) Patent Application Publication
(10) Pub. No.: US 2026/0178964 A1
(43) Pub. Date: Jun. 25, 2026

(54) STREAMING BASED GENERATIVE ARTIFICIAL INTELLIGENCE (AI) WORKLOAD EXECUTION

(71) Applicant: Advanced Micro Devices, Inc., Santa Clara, CA (US)

(72) Inventor: Hisham Chowdhury, El Dorado Hills, CA (US)

(21) Appl. No.: 18/988,469

(22) Filed: Dec. 19, 2024

(51) Int. Cl. G06N 20/00

(52) U.S. Cl. CPC G06N 20/00

(57) ABSTRACT

An apparatus and method for efficiently performing efficient data storage and data transfer of machine learning data. In various implementations, a host processing circuit of a computing system executes a machine learning (ML) application. The application includes a computational graph that indicates the computational order of the ML nodes, layers, and stages of the ML model. The host processing circuit translates function calls in the application to commands particular to an accelerator circuit. The accelerator circuit preloads weights to be used by ML nodes of the ML model by retrieving compressed weights from a storage device different from system memory. The accelerator circuit uses a streaming application programming interface (API) and bypasses the host processing circuit to retrieve the compressed weights from the storage device. The accelerator circuit decompresses the retrieved weights and executes the ML node using the decompressed weights.

### BACKGROUND

### Description of the Relevant Art

The parallelization of tasks is used to increase the throughput of computing systems. To this end, compilers extract parallelized tasks from applications to execute in parallel on the computing system hardware. Parallel data processing circuits execute multiple threads simultaneously in order to take advantage of the identified instruction-level parallelism. The performance of computing systems increases with the scheduling of parallel data tasks on parallel data processing circuits. One or more of these parallel data processing circuits can support a machine learning (ML) model. The ML model uses machine learning techniques that rely on one of a variety of types of neural network structures. The ML model uses one or more layers of nodes to generate an output value representing a prediction when given a set of input data values.

With the addition of one or more parallel data processing circuits, the computing system hardware supports the data computing requirements of executing the instructions of the ML model. However, the computing system hardware also needs to support the data storage requirements and the memory bandwidth requirements of the ML model. The parameters of the ML model include the input data values, the weight values, the bias values, and the activation values. In some designs, a representative number of the relatively high number of these parameters used by the ML model can range from tens of billions of parameters to hundreds of billions of parameters. In some designs, a representative amount of data storage of these parameters in one memory can range from hundreds of gigabytes to a few terabytes with data transfer rates reaching hundreds of gigabytes per second.

The computing system typically includes second memory such as an off-chip hard disk drive or solid-state drive. Examples of the user's computing device that includes the computing system are a desktop computer, a laptop computer, a tablet computer, a smartphone, a smartwatch and so forth. Even if the secondary memory can support the above data storage requirement, the other levels of the memory hierarchy located closer to the one or more parallel processing circuits typically can't provide the data storage requirement and data transfer rates for supporting execution of the ML model. Therefore, the performance suffers, or the computing device is unable to execute applications relying on the ML model.

In view of the above, methods and apparatuses for efficient support of machine learning model data storage requirements and data transfer rates requirements are desired.

### BRIEF DESCRIPTION OF THE DRAWINGS

FIG. 1 is a generalized diagram of a sequence diagram in a computing system that performs efficient data storage and data transfer of machine learning data.

FIG. 2 is a generalized diagram of a machine learning model that performs efficient data storage and data transfer of machine learning data.

FIG. 3 is a generalized diagram of a machine learning initial attention stage that performs efficient data storage and data transfer of machine learning data.

FIG. 4 is a generalized diagram of an attention layer of a machine learning model.

FIG. 5 is a generalized diagram of encoder and decoder block components of a machine learning model.

FIG. 6 is a generalized diagram of processing stages of a transformer of a machine learning model.

FIG. 7 is a generalized diagram of a computational graph of a machine learning model.

FIG. 8 is a generalized diagram of a method for performing efficient data storage and data transfer of machine learning data.

FIG. 9 is a generalized diagram of a computing system that performs efficient data storage and data transfer of machine learning data.

FIG. 10 is a generalized diagram of an apparatus that performs efficient data storage and data transfer of machine learning data.

FIG. 11 is a generalized diagram of a method for performing efficient data storage and data transfer of machine learning data.

FIG. 12 is a generalized diagram of a sequence diagram in a computing system that performs efficient data storage and data transfer of machine learning data.

While the invention is susceptible to various modifications and alternative forms, specific implementations are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the scope of the present invention as defined by the appended claims.

### DETAILED DESCRIPTION

In the following description, numerous specific details are set forth to provide a thorough understanding of the present invention. However, one having ordinary skill in the art should recognize that the invention might be practiced without these specific details. In some instances, well-known circuits, structures, and techniques have not been shown in detail to avoid obscuring the present invention. Further, it will be appreciated that for simplicity and clarity of illustration, elements shown in the figures have not necessarily been drawn to scale. For example, the dimensions of some of the elements are exaggerated relative to other elements.

Apparatuses and methods for performing efficient data storage and data transfer of machine learning data are disclosed. In various implementations, the host processing circuit of the computing system executes a machine learning (ML) parallel data application. In various implementations, the application is written by a developer in one of a variety of high-level programming languages such as Python, R, Julia, C, C++, C#, and Java and so on. Machine learning libraries can be used with these high-level programming languages to provide predefined modules to aid developers when building the ML application (ML model). Examples of the ML libraries are TensorFlow, Pytorch, Numpy, Keras, Matplotlib, Pandas and so on. A predefined module can be called similar to a function call. The imported ML libraries are used to create computational graphs that provide the computational order (or computation order) of the ML nodes, layers and stages of the ML model. The host processing circuit uses a library that relies on a user mode driver (UMD) to translate function calls in the ML application to commands particular to a piece of hardware such as an accelerator circuit with a parallel data microarchitecture.

The accelerator circuit preloads (prefetches) compressed weights from a storage device separate from system memory. The preloading occurs prior to the ML nodes of the ML model being executed. The preloading of the compressed weights does not utilize the host processing circuit or the system memory. Therefore, latency of executing the ML model reduces and performance increases. Typically, computing systems load the weights onto the local memory prior to executing the ML model and the local memory capacity is filled without having loaded all of the weights for the ML model. When required weights are not found in the local memory, in prior computing systems, the accelerator circuit loads the weights from system memory while relying on the host processing circuit and file system application programming interface (API) to access the weights on the system memory. These steps increase latency of executing the ML model and performance reduces. In contrast to these typical steps taken by prior computing systems, the accelerator circuit of the proposed solution uses a streaming application programming interface (API).

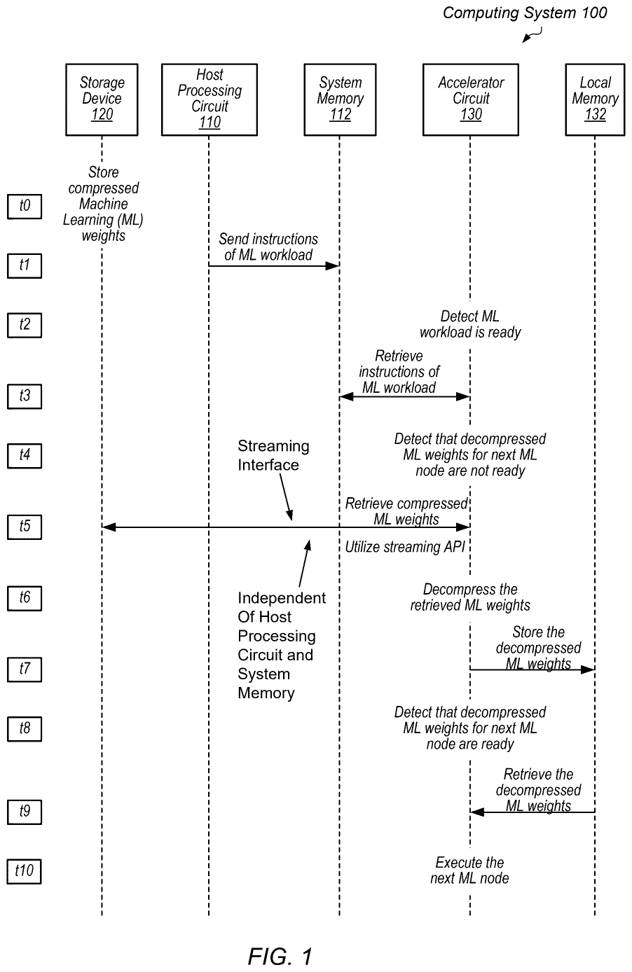

When using the streaming API, the accelerator circuit bypasses the host processing circuit, the file system API, and the system memory to retrieve the compressed weights from the storage device. In some implementations, the storage device is a non-volatile memory express (NVMe) storage device that utilizes a solid-state disk (SSD) storage capability. The accelerator circuit decompresses the retrieved weights and stores the decompressed weights in the local memory of the accelerator circuit. The accelerator circuit executes the ML node using the decompressed weights. For example, the accelerator circuit adds the ML node to a work queue (or machine learning queue or scheduler queue) that includes a pointer to the storage location of the local memory that stores the decompressed weights. Further details of these techniques for performing efficient data storage and data transfer of machine learning data are provided in the following description of FIGS. 1-12.

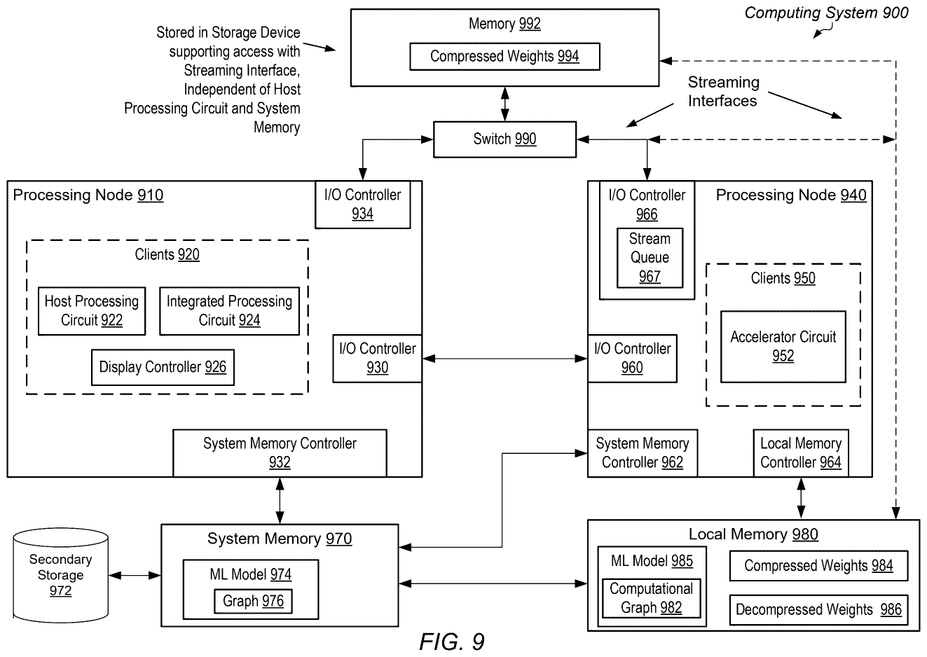

Turning now to FIG. 1, a generalized diagram is shown of a sequence diagram 100 that performs efficient data storage and data transfer of machine learning data. As shown, a computing system includes a host processing circuit 110 connected to each of system memory 112 and storage device 120. The computing system also includes an accelerator circuit 130 connected to each of system memory 112 and local memory 132. In various implementations, the host processing circuit 110 is a general-purpose processing circuit, such as a central processing unit (CPU), that executes instructions of a host operating system of the computing system. The accelerator circuit 130 is a parallel data processing circuit with a highly parallel data microarchitecture. An example of the accelerator circuit 130 (parallel data processing circuit) is parallel data processing circuit 952 of computing system 900 (of FIG. 9). Examples of the accelerator circuit 130 are a graphics processing unit (GPU), a digital signal processing circuit (DSP), a field programmable gate array (FPGA), and an application specific integrated circuit (ASIC). Yet other examples of the accelerator circuit 130 are an embedded inference processing unit (EIPU) or an embedded inference processing circuit, an artificial intelligence (AI) accelerator processing circuit (an accelerator device), a neural processing unit (NPU) or a neural processing circuit, a tensor processing unit (TPU) or a tensor processing circuit, a multiprocessing circuit, and so on.

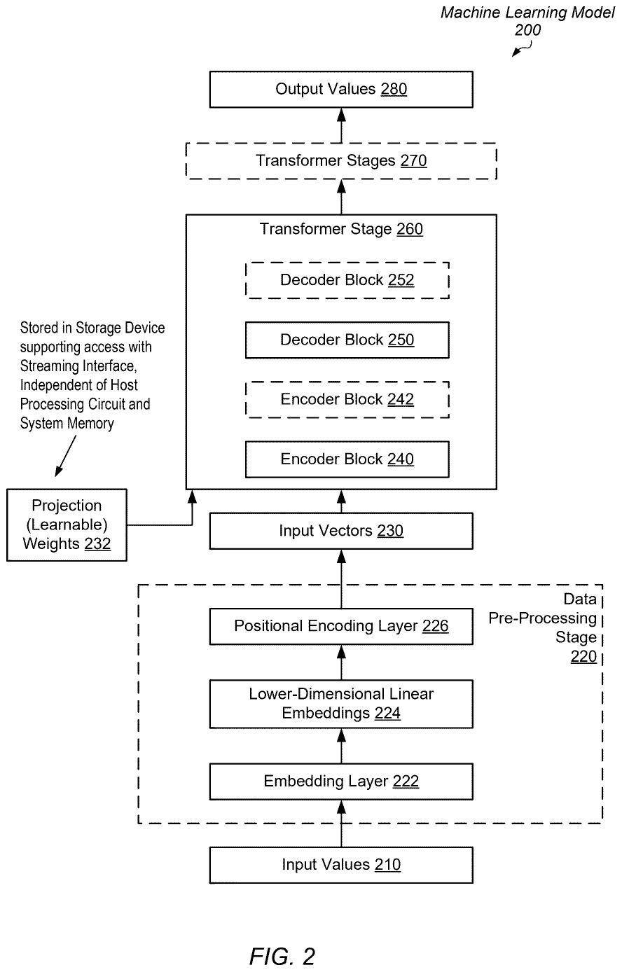

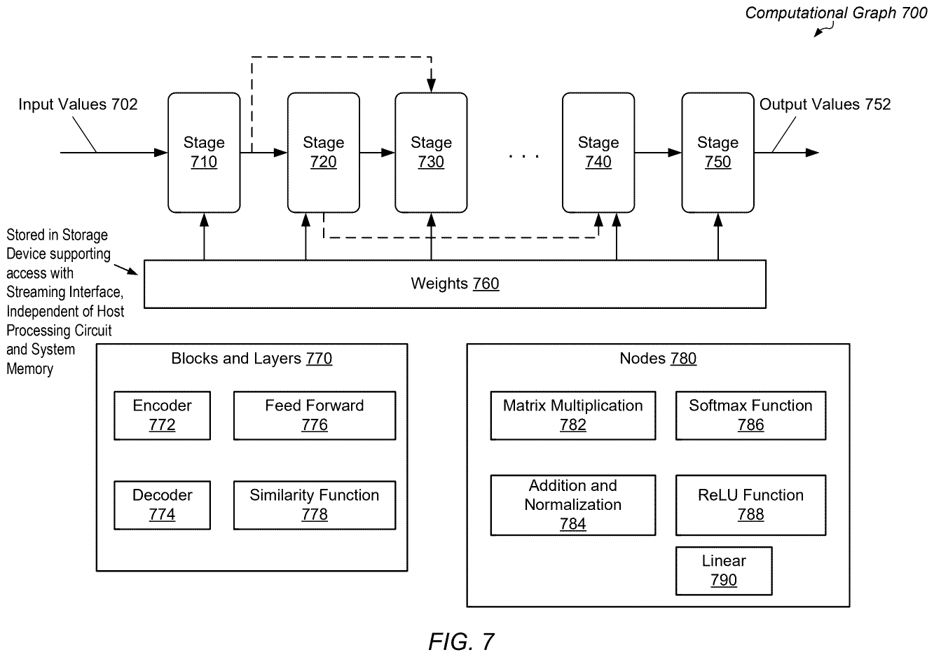

Host processing circuit 110 and accelerator circuit 130 execute a variety of types of parallel data applications such as a variety of types of machine learning (ML) models and ML stages, layers and nodes used to construct the ML models. The ML models include multiple trained ML models that use machine learning techniques relying on one or more of generative adversarial networks (GANs), diffusion models, a recurrent neural network (RNN) structure, a convolutional neural network (CNN) structure, a deep neural network (DNN) structure, a transformer block with an encoder-decoder architecture, and so forth. The neural network structures can be used to construct larger ML models such as generative artificial intelligence (Gen AI) models and large language models (LLMs). An example of the ML model is ML model 200 (of FIG. 2). Typically, one or more of host processing circuit 110 and accelerator circuit 130 executes the instructions of stages, layers and nodes in a computational order based on a computational graph such as computational graph 700 (of FIG. 7).

It is noted that the sequence diagram provided herein are provided for ease of discussion and are not intended to indicate a strict ordering of events. Rather, some of the events may occur concurrently and may occur in a different order. At time t0, one or more of host processing circuit 110 and accelerator circuit 130 compress machine learning weights (or weights) of a trained ML model. In an implementation, compression is performed without pruning or quantizing the weights. Therefore, precision of the weights is not reduced when the weights are later decompressed. In some implementations, the ML model is one of a variety of types of a large language model (LLM). Storage device 120 stores the compressed weights. In an implementation, storage device 120 is a non-volatile memory express (NVMe) storage device utilizing solid-state disk (SSD) storage. In other implementations, storage device 120 is another type of data storage. It is noted that storage device 120 is separate from each of system memory 112 and local memory 132. In an implementation, each of system memory 112 and local memory 132 is one of a variety of types of synchronous random-access memory (SRAM).

At time t1, host processing circuit 110 begins processing the instructions of the ML model and a library uses a user mode driver (UMD) to translate instructions of function calls in the application to commands particular to a piece of hardware such as accelerator circuit 130. The commands include machine learning operations. The commands are included in at least a computational graph (not shown) stored in local memory 132 after initial storage in system memory 112. At time t2, accelerator circuit 130 detects the ML workload is ready. In an implementation, host processing circuit 110 directly informs accelerator circuit 130 through a Peripheral Component Interconnect Express (PCIe) bus or accelerator circuit 130 detects a doorbell or flag has been updated in system memory 112. At time t3, accelerator circuit 130 retrieves the instructions of the ML workload.

At time t4, based on the computational graph corresponding to the ML model being executed by accelerator circuit 130, the accelerator circuit 130 detects a next machine learning (ML) node to execute. Accelerator circuit 130 verifies whether local memory 132 stores the required decompressed weights for the next ML node. If the decompressed weights are unavailable for the next ML node in the local memory 132, then at time t5, accelerator circuit 130 retrieves the required compressed weights from compressed weights in storage device 120 different from system memory 112. In other implementations, at time t4, accelerator circuit 130 detects required decompressed weights for an earlier ML node other than the next ML node are not ready in local memory 132. In response, accelerator circuit 130 schedules a streaming memory access request to retrieve the required compressed weights from compressed weights in storage device 120 different from system memory 112. In an implementation, the next ML node to execute by accelerator circuit 130 is ML node 5. However, accelerator circuit 130 has already scheduled and executed streaming memory access requests for compressed weights used by ML nodes 1 to 6. Therefore, accelerator circuit 130 has preloaded (prefetched) the required compressed weights earlier than when the corresponding ML nodes are ready to execute.

When preloading (prefetching) the required compressed weights earlier than when the corresponding ML nodes are ready to execute, in some implementations, accelerator circuit 130 limits how far ahead to prefetch in order to avoid reaching the data storage capacity of local memory 132. In an implementation, accelerator circuit 130 stops prefetching compressed weights when the available data storage capacity of local memory 132 is less than the first data storage threshold. Accelerator circuit 130 begins to prefetch compressed weights again when the available data storage capacity of local memory 132 is greater than a second data storage threshold. In another implementation, accelerator circuit 130 stops prefetching when a difference between the identifier (ID) of the ML node having compressed weights prefetched and the ID of the ML node being executed exceeds a first difference threshold. Accelerator circuit 130 begins to prefetch compressed weights again when the difference is less than a second difference threshold.

In yet another implementation, accelerator circuit 130 stops prefetching when the amount of decompressed weights that have been prefetched ahead of the currently executing ML node exceeds a third data storage threshold. Accelerator circuit 130 begins to prefetch compressed weights again when the amount of decompressed weights that have been prefetched ahead of the currently executing ML node is less than a fourth data storage threshold. In other implementations, a variety of other conditions and mechanisms and combinations of these conditions and mechanisms can be used to enable and disable prefetching of compressed weights from storage device 120 to local memory 132. In some implementations, the corresponding thresholds are stored in programmable configuration and status registers (CSRs). It is noted that although the arrow at time t5 is shown to end at accelerator circuit 130, in other implementations, local memory 132 is located inside accelerator circuit 130 and a queue of local memory 132 receives and stores the retrieved compressed weights.

In an implementation, at time t5, accelerator circuit 130 adds, in a streaming queue (or stream queue) of a corresponding I/O controller, a streaming memory access request that targets the required compressed weights. Accelerator circuit 130 directly sends the memory access request to the storage device 120 using a streaming application programming interface (API) that provides direct access to data stored in storage device 120 without involvement from host processing circuit 110 or system memory 112. Therefore, accelerator circuit 130 directly accesses storage device 120 without involvement from host processing circuit 110 or system memory 112.

In some implementations, accelerator circuit 130 supports Microsoft DirectStorage API for direct memory accesses of storage device 120 without involvement from host processing circuit 110 and without use of file system APIs. Therefore, no file system API is used. Accordingly, access latency is reduced when compared to retrieving weights from system memory 112 and relying on host processing circuit 110 and file system APIs. At time t6, accelerator circuit 130 decompresses the received weights. At time t7, accelerator circuit 130 stores the decompressed weights in local memory 132. At time t8, accelerator circuit 130 detects that the required decompressed ML weights for the next ML node are ready. At time t9, accelerator circuit 130 retrieves the decompressed ML weights from local memory 132.

At time t10, accelerator circuit 130 executes the next ML node using the retrieved and decompressed weights. For example, accelerator circuit 130 adds the ML node to a work queue (or machine learning queue or scheduler queue) that includes a pointer to the storage location of the local memory 132 that stores the decompressed weights. Therefore, the same device or processing circuit (accelerator circuit 130) both decompresses the retrieved weights and executes the ML operators of the ML nodes, layers and stages that utilize the decompressed weights. Accordingly, no further copies of the decompressed weights besides the decompressed weights stored in local memory 132 are used in the computing system. The weights are retrieved and decompressed “just-in-time” as the ML model needs them, which provides tight synchronization between storage of required weights and usage of the required weights during execution of the corresponding ML nodes, layers and stages. To support the “just-in-time” retrieval and decompression of the weights required by the ML stages, the accelerator circuit 130 utilizes a streaming application programming interface (API) that provides direct access to data stored in the storage device 120 without involvement from the host processing circuit 110 or system memory 112.

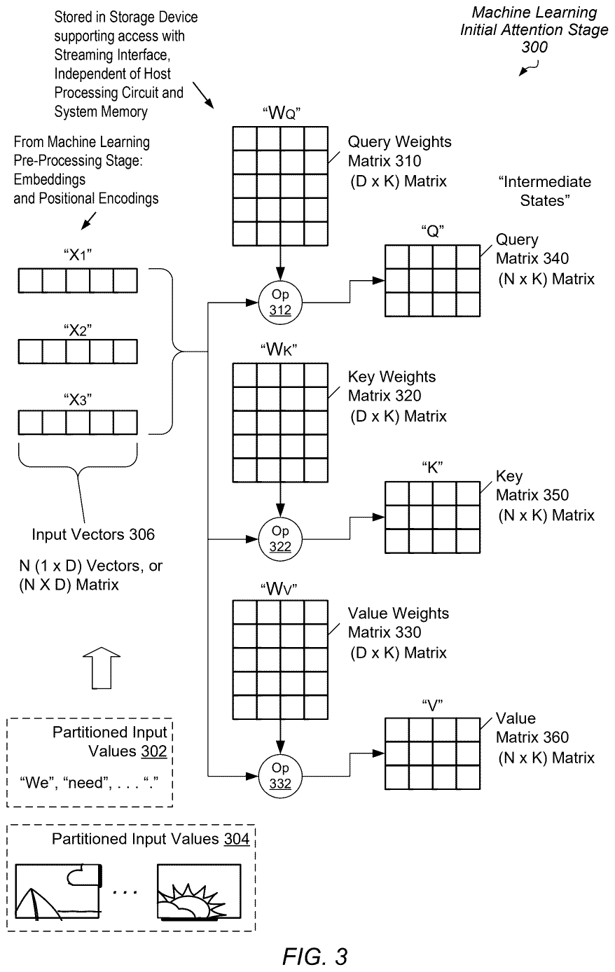

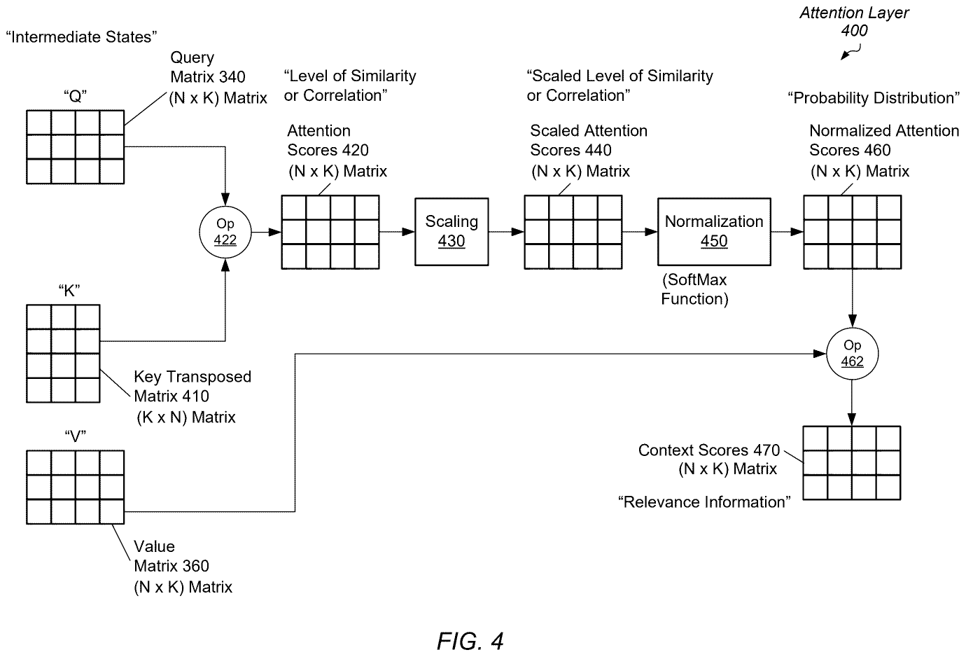

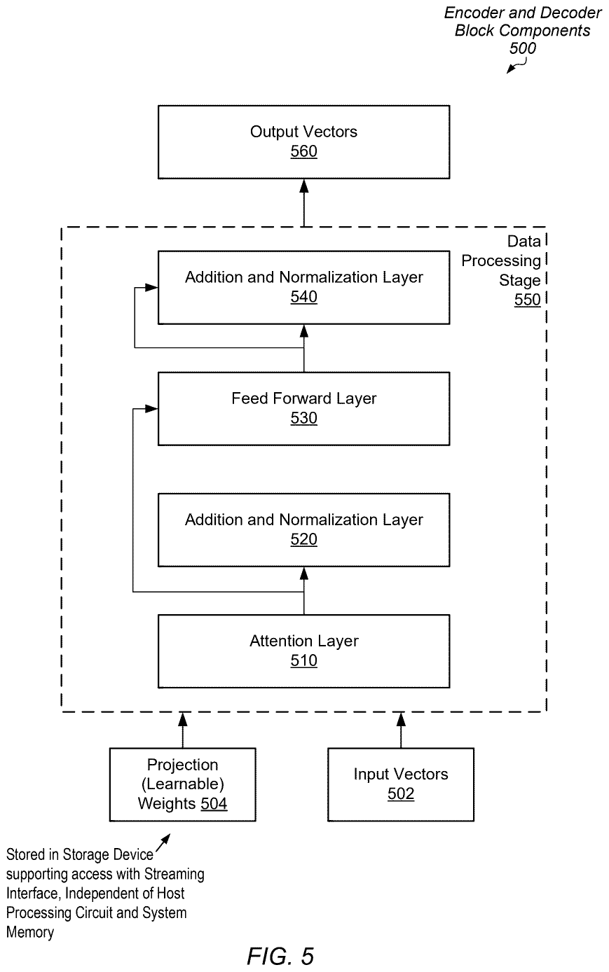

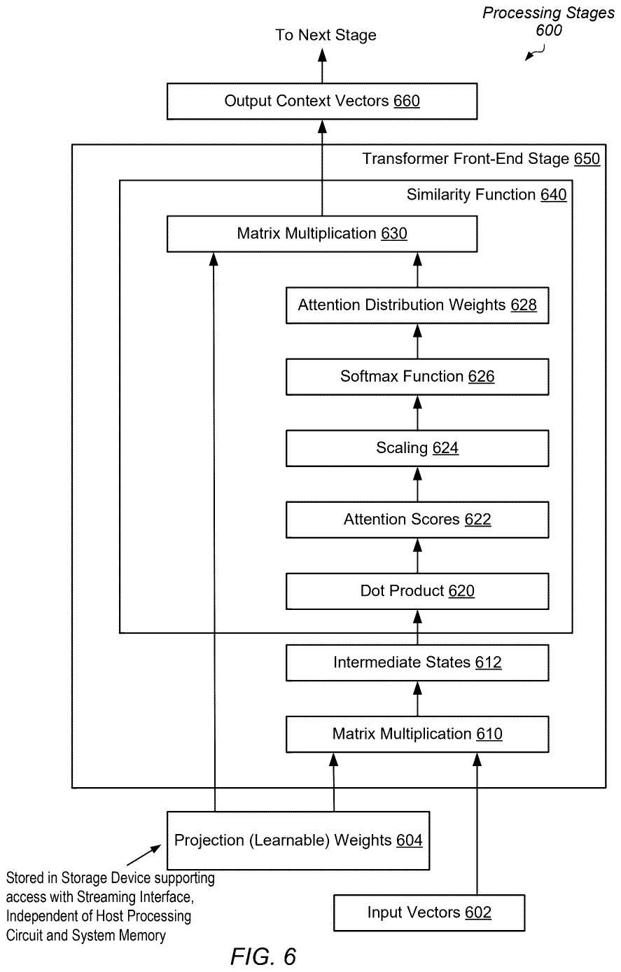

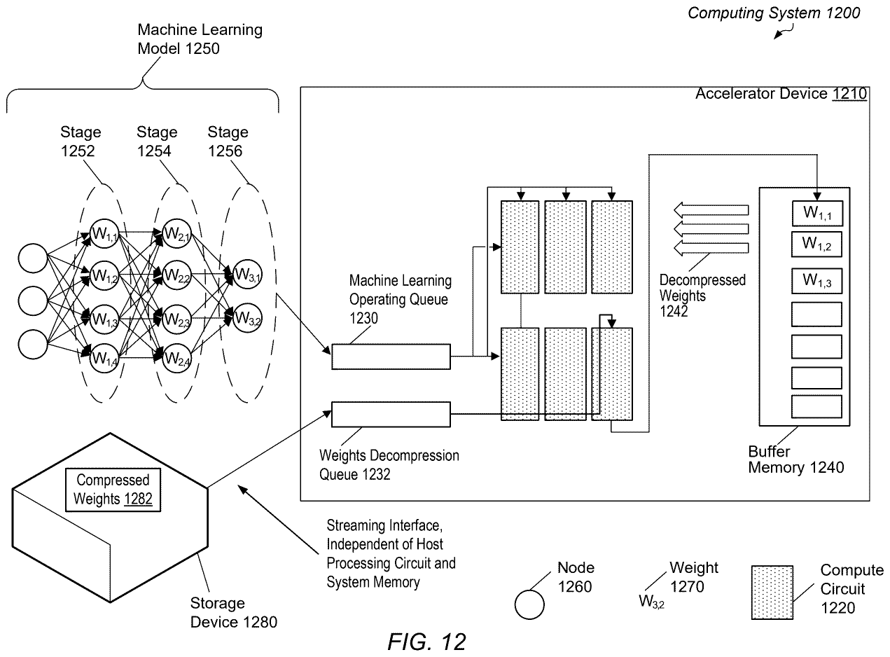

In the following description of FIGS. 2-12, a machine learning model 200 (of FIG. 2) is described that utilizes the transformer stage 260 that includes an encoder-decoder architecture. This encoder-decoder architecture relies on components 500 (of FIG. 5) and processing stages 600 (of FIG. 6). The components 500 and processing stages 600 utilize stage 300 (of FIG. 3) and attention layer 400 (of FIG. 4). The ML model 200 is used to create ML model 974 (of FIG. 9) and ML model 1250 (of FIG. 12). The number and arrangement of the layers and stages of ML model 200 is based on a computational graph, such as computational graph 700 (of FIG. 7), set up by designers of ML model 200. Similar to the steps described in the sequence diagram of the computing system 100, the weights are retrieved and decompressed “just-in-time” (or “on-demand”) as the ML model 200 needs them, which provides tight synchronization between storage of required weights and usage of the required weights during execution of the corresponding ML nodes, layers and stages of ML model 200.

Referring to FIG. 2, a generalized diagram is shown of a machine learning model 200 that performs efficient data storage and data transfer of machine learning data. As shown, machine learning model 200 includes data pre-processing stage 220 and transformer stage (or model or layer) 260. In some implementations, machine learning model 200 includes one or more additional transformer stages such as at least transformer stage 270, which is shown in a dashed box since it is optional and can include more than one transformer stage. Data pre-processing stage 220 receives input values 210 and generates input vectors 230, which are sent to transformer stage 260. Transformer stage 260 (and any additional transformer stages 270) uses input vectors 230 to generate output values 280.

By using transformer stages (or models or layers) 260 (and any additional transformer stages 270), machine learning model 200 uses a neural network structure to generate output values 280 from input values 210 based on at least tracking relationships and relevance between elements of an input sequence (input values 210) and tracking long term dependencies or relationships with prior input values 210. Transformer stage (or model or layer) 260 (and any additional transformer stages 270) utilizes attention and self-attention mathematical techniques to track dependencies or relationships among elements of the input values 210 and previous input values. In various implementations, machine learning model 200 is a large language model (LLM), which includes multiple transformer stages relying on self-attention mathematical techniques for processing natural language processing (NLP) applications.

Natural language processing (NLP) applications generate content such as answers to questions or paragraphs of an article, provide language translations of sentences and phrases, generate predictions and/or recommendations of search queries, generate classifications of input images, generate images and video frames based on user input, and so forth. Examples of LLMs are Generative Pre-trained Transformer 4 (GPT-4) developed by OpenAI, Inc., Large Language Model Meta AI (Llama or LLaMA) and LLaMA 2 developed by Meta AI, Orca developed by Microsoft Corp., Mistral 7B developed by Mistral AI, Stable Diffusion developed by Stability AI, and so forth. Other examples of LLMs are a variety of types of vision transformers (ViT) such as LLMs that utilize Cross-Shaped Window (CSWin) transformer blocks, LLMs that rely on Cross-Attention Multi-Scale Vision Transformer (CrossViT) blocks, LLMs that rely on Data-Efficient Image Transformer (DEIT) blocks, and so forth. In various implementations, ML model 200 utilizes the transformer stage 260 that includes an encoder-decoder architecture that relies on components 500 (of FIG. 5) and processing stages 600 (of FIG. 6) to create ML model 974 (of FIG. 9) and ML model 1250 (of FIG. 12).

In some implementations, input values 210 are values of a user query that includes a user identifier (ID) and a movie title, a music song title or other item for purchasing or searching that has a corresponding item ID, and the output values 280 include a selection (mouse click) probability on another movie title, song title or other similar item on a web page. In other implementations, input values 210 are input text from a user for a natural language processing (NLP) application. The type of NLP application determines the type of output values 280 generated by transformer stage 260 (and any additional transformer stages 270). The NLP applications can include language translation services, virtual assistants, chatbots, and so forth. In yet other implementations, the input values 210 are patches or subsets of a video frame or an image and the output value 280 is a classification or identifying category of the entire image or multiple classifications of multiple objects in the image. Examples of input values 210 are also shown in FIG. 3 as partitioned input values 302, which includes text inputs and punctuation marks of a user query, and partitioned input values 304, which are patches of an input image. Multiple other examples of input values 210 and output values 280 are also possible and contemplated.

Embedding layer 222 of data pre-processing stage 220 converts each input value (or token) of input values 210 to a multi-dimension embedding (embedding vector). In an implementation, the input values 210 includes the sentence “We need coffee.” Each element (word or token or punctuation mark) of the input sequence (sentence that represents input values 210) is converted to a D-dimension embedding vector such as a vector with “D” floating-point numbers where “D” is a positive, non-zero integer. In a simplified implementation, D is 4 and the embedding layer 222 converts the word “coffee” of input values 210 to the 4-dimensional vector (or embedding) equal to [0.674, 0.002, −0.395, 0.983]. Embedding layer 222 performs a similar conversion (mapping) for the other elements (or tokens) “We” and “need” and the punctuation period “.” of the input sequence (input values 210).

In the above example, dimension D is kept small for illustrative purposes. However, in other implementations, another value for dimension D is used based on design requirements. For example, dimension D can be 16, and embedding layer 222 converts the word “coffee” of input values 210 to a 16-dimensional vector (or embedding vector) that includes 16 floating-point numbers. Dimension D can also be 512, and embedding layer 222 converts the word “coffee” of input values 210 to a 512-dimensional vector (or embedding vector) that includes 512 floating-point numbers. In yet other implementations, input values 210 includes three non-overlapping patches or subsets of an image or video frame and embedding layer 222 converts each of the three patches to a D-dimensional vector (or embedding vector). In another example, the image or video frame can be divided into nine respective, non-overlapping and equal-sized patches. When D is 256, the patch that is the top right corner of the image or video frame is converted into an embedding vector with 256 floating-point numbers. Similarly, each of the other eight patches of the total nine patches is converted to a corresponding and unique 256-dimension embedding vector.

Lower dimensional linear embeddings 224 (or embeddings 224) represent the D-dimension vectors (embedding vectors) generated by embedding layer 222. These embeddings 224 are D-dimension numerical representations, which are also referred to as “embedding vectors.” As used herein, each element or individual input value of input values 210 can be referred to as a “token.” In some implementations, each element (or token) of input values 210 is converted into a D-dimension embedding vector by a lookup operation of an embedding table. To generate a D-dimension embedding vector for each of the tokens of input values 210, in some implementations, a variety of mapping techniques can be used to map the embeddings 224 tokens to “latent space vectors” or “latent vectors” or “embedding rows.” Tokenization and mapping cause the original data of input values 210 to be mapped from a higher-dimensional space to a lower-dimensional space while preserving the meaning of the original data. Examples of these other mapping techniques are the Principal Component Analysis (PCA) technique, the Singular Value Decomposition (SVD) technique, the Word2Vec technique, the t-SNE (t-Distributed Stochastic Neighbor Embedding) technique, the UMAP (Uniform Manifold Approximation and Projection) technique, and so forth.

Data pre-processing stage 220 also includes positional encoding 226. Positional encoding layer 226 maps a position of an element of an input sequence, such as input values 210, to a vector of numerical representations. For example, when input values 210 is a sequence of ten textual words or a sequence of ten patches of an image, positional encoding layer 226 provides a unique vector with “D” numerical representations for each of the ten positions within the sequence. Therefore, by using the vectors, positional encoding 226 identifies which textual word or patch is the first element in the sequence of input values 210, identifies which textual word or patch is the second element in the sequence, identifies which textual word or patch is the third element in the sequence, and so on. Positional encoding layer 226 does not use a single numerical value, such as a positional index, for each element of the input sequence since the input sequence can be large and the resulting magnitudes of the indices would be large. The large magnitude would cause the indices to consume a large amount of data storage of the hardware resources of the computing system.

In some implementations, positional encoding layer 226 utilizes one or more of the trigonometric sine function and the trigonometric cosine function to generate the unique numerical representations (positional encoding vectors) to place in the vectors that specify the positional encodings. The frequencies of the selected trigonometric function (sine or cosine) can be set to depend on one or more of the dimension of the embeddings 224, the position of the element in the input sequence (input values 210), the position of the numerical representation within the vector of the element, user-defined values, and so forth. In other implementations, a variety of other functions and methods are used to generate the positional encoding vectors. To generate the input vectors 230, positional encoding layer 226 combines the embedding layer 222 with the positional encoding vectors. In an implementation, for each element of the input sequence (input values 210), positional encoding layer 226 sums each numerical representation in the embedding layer 222 with a corresponding numerical representation of the positional encoding vectors. In other implementations, positional encoding layer 226 combines the embedding layer 222 with the positional encoding vectors using a variety of other mathematical computations.

Transformer stage (or model or layer) 260 receives the input vectors 230 from the data pre-processing stage 230. Transformer stage 260 also receives the projection (learnable) weights 232, which are machine learning weights. Transformer stage 260 generates output values, which are used as outputs of machine learning model 200, such as output values 280, or used as inputs to a subsequent transformer stage such as transformer stage 270. Unlike a recurrent neural network (RNN), such as a long short term memory (LSTM) neural network, and other types of neural networks that are sequential machine learning models relying on recurrence and relationships of nearby elements of an input sequence (input values 210), transformer stage 260 provides parallel processing relying on relationships concurrently across all elements of the input sequence. For example, positional encoding layer 226 provided the relationships in the form of positional encoded vectors to be used by transformer stage 260. These positional encoded vectors were combined with the embeddings 224 to generate the input vectors 230.

As described earlier, transformer stages 260 (and 270) utilize self-attention mathematical techniques. These techniques numerically characterize relationships, dependencies and relevance between tokens of the input values 210. These techniques provide context information among the tokens. For example, the token “store” in a sentence or phrase can be a noun such as a physical building or online website where customers shop for items. The token “store” can also be a verb for holding an item in a location for later use. The context and relationships among other tokens provide the actual meaning of the token “store.” To provide the attention mathematical techniques that include relevance and context information, transformer stage 260 utilizes the projection (learnable) weights 232 (or weights 232). A further description of weights 232 is provided in the description of machine learning initial stage 300 of FIG. 3.

Transformer stage 260 includes one or more encoder blocks, such as encoder block 240 and 242, and one or more decoder blocks, such as decoder block 250 and 252. In various implementations, components of the encoder blocks 240 and 242 and the decoder blocks 250 and 252 are similar. For example, as illustrated in encoder and decoder block components 500 of FIG. 5, encoder and decoder block components can include an attention layer, one or more addition and normalization layers, and a feed forward layer. These layers receive input vectors and generate output vectors. The number and arrangement of the layers is based on a computational graph, such as computational graph 700 (of FIG. 7), set up by designers of the machine learning model.

Referring to FIG. 3, a generalized diagram is shown of a machine learning initial attention stage 300 that performs efficient data storage and data transfer of machine learning data. As shown, machine learning initial attention stage 300 (or stage 300) receives input vectors 306 and generates the intermediate states that include the matrices 340, 350 and 360. In various implementations, an embedding layer (not shown), such as embedding layer 222 of data pre-processing stage 220 (of FIG. 2), converts each input value (or token) of partitioned input values 302 or 304 to a multi-dimension embedding (embedding vector) such as one of input vectors 306. Partitioned input values 302 includes text inputs and punctuation marks of a user query. Partitioned input values 304 are patches of an input image. Although shown together, stage 300 utilizes one of the partitioned input values 302 and 304 to generate a particular set of the intermediate states that include the matrices 340, 350 and 360. The partitioned input values 302 and 304 are not mixed together.

As shown, partitioned input values 302 includes text words and punctuation marks of a user query such as a sentence, phrase or question. Each element (word or token or punctuation mark) of the user query is converted to a D-dimension embedding vector such as a vector with “D” floating-point numbers where “D” is a positive, non-zero integer. One of the input vectors 306 represents this D-dimension embedding vector in a simplified implementation. For example, the embedding layer converts the token “We” to the D-dimension embedding vector “X₁” of input vectors 306, converts the token “need” to the D-dimension embedding vector “X₂” of input vectors 306, and so forth. In another implementation, embedding layer converts the token that is a patch or subset of a video frame or still image to the D-dimension embedding vector “X₁” of input vectors 306, converts a second patch to the D-dimension embedding vector “X₂” of input vectors 306, and so forth. A positional encoding layer (not shown), such as positional encoding layer 226 of FIG. 2, combines the embedding vectors with corresponding positional encoding vectors to generate the final numerical representations of input vectors 306. Although three input vectors of input vectors 306 are shown, in various implementations, another number of input vectors is used based on design requirements.

The circuitry (not shown) of stage 300 receives the input vectors 306 and receives the projection (learnable) weights 310, 320 and 330, which are machine learning model weights. The circuitry (not shown) of stage 300 generates the intermediate states that include the matrices 340, 350 and 360. As described earlier, transformer stages utilize self-attention mathematical techniques. These techniques numerically characterize relationships, dependencies and relevance between tokens of the input values and tokens of a database to provide probabilities of correct responses or generative content. These techniques provide context information among the tokens. For example, the token “right” in a sentence or phrase can indicate a direction, which is the opposite of “left,” or it can indicate whether a response is correct or incorrect. The context and relationships among other tokens provide the actual meaning of the token “right.” To provide the attention mathematical techniques, stage 300 utilizes the query weights matrix 310, the key weights matrix 320, and the value weights matrix 330.

In various implementations, the circuitry of stage 300 combines the input vectors 306 into a matrix. The circuitry of operator (“Op”) 312 performs matrix multiplication using the query weights matrix 310 and the matrix that includes input vectors 306. Each of the input vectors 306 is a (1×D) vector, and when N vectors are placed together in a matrix, the result is an N×D matrix. The query weights matrix 310 is a (D×K) matrix, and the resulting query matrix 340 is an (N×K) matrix. To generate the query matrix 340, operator 312 performs matrix multiplication using the query weights matrix 310 and the matrix that includes input vectors 306. Here, N, D and K are positive, non-zero integers. Similarly, to generate the key matrix 350, operator 322 performs matrix multiplication using the key weights matrix 320 and the matrix that includes input vectors 306. To generate the values matrix 360, operator 332 performs matrix multiplication using the values weights matrix 330 and the matrix that includes input vectors 306.

Referring to FIG. 4, a generalized diagram is shown of an attention layer 400 of a machine learning model. As shown, attention layer 400 receives intermediate states and generates the context scores 470. In various implementations, the intermediate states include the query matrix 340 and value matrix 360 (of FIG. 3) and the key transposed matrix 410, which is a transpose of the key matrix 350 (of FIG. 3). The circuitry of the operator 422 performs a dot product of matrices 340 and 410 to generate the attention scores 420. With the query matrix 340 being an (N×K) matrix and the matrix 410 being a (K×N) matrix, the attention scores 420 is an (N×K) matrix. The attention scores 420 provides a numerical representation of the similarities between the query matrix 340 and the key transposed matrix 410. The scaling block 430 multiples each matrix element of the attention scores 420 by a scaling factor to generate the scaled attention scores 440, which includes an (N×K) matrix. Scaling block 430 performs scaling to stabilize the attention layer 400. The multiplication of the matrix elements can lead to very large data values, so the matrix elements are reduced by a scaling factor. In some implementations, the scaling factor is the inverse of the square root of dimension D. Therefore, each of the matrix elements of the matrix of the attention scores 420 is divided by the square root of dimension D.

To generate the normalized attention scores 460, the normalization block 450 performs a normalization operation on the scaled attention scores 440. The resulting (N×K) matrix of the normalized attention scores 460 includes each matrix element with a floating-point value between 0 and 1. In various implementations, each row of the resulting (N×K) matrix of the normalized attention scores 460 sums to 1. In some implementations, the normalization operation provides a higher emphasis on higher scaled attention scores and provides a lower emphasis on lower scaled attention scores. Normalization block 450 determines which tokens of an input sequence (input values) should receive more attention for a particular input token. Normalization block 450 generates numerical representations of the relevance of tokens between themselves. When using the normalization block 450, larger scaled attention scores of the scaled attention scores 440 correspond to larger probabilities in the input components will correspond to larger probabilities in the normalized attention scores 460.

In various implementations, normalization block 450 uses the SoftMax function (or SoftMax function) to perform the normalization operation. For a particular matrix element of a first row of the scaled attention scores 440, the softmax function (or softargmax function or normalized exponential function) uses the exponential operation on the matrix element and normalizes the resulting value by dividing the resulting value by the sum of the resulting values of the entire vector. For example, if a vector (row of a matrix) includes the values [0.24, −3.7, 4.3], then the exponentials of each of the elements is [1.27, 0.0247, 73.70]. The sum is (1.27+0.0247+73.70) or 74.99. The softmax function result for the first element of the vector is (1.27/74.99) or 0.0169. The softmax function result for the vector is [0.0169, 0.000329, 0.983]. These operations are performed for each row (vector) of the scaled attention scores 440 to generate the matrix of the normalized attention scores 460. Afterward, the operator 462 performs matrix multiplication using the matrix of the normalized attention scores 460 and the value matrix 960. The result is the matrix of the context scores 470.

Turning now to FIG. 5, a generalized diagram is shown of encoder and decoder block components 500 of a machine learning model. As shown, encoder and decoder block components 500 (or components 500) receive input vectors 502 and generate output vectors 560 using the data processing stage 550 (or stage 550). In some implementations, stage 550 includes an attention layer 510, one or more addition and normalization layers, such as layers 510 and 540, and a feed forward layer 530. Attention layer 510 generates numerical representations of the relevance of tokens between themselves. Further steps to do this operation are provided in the description of the machine learning initial stage 300 (of FIG. 3), the attention layer 400 (of FIG. 4) and the similarity function 640 (of FIG. 6). The addition and normalization layers 520 and 540 combine values of vectors (rows of matrices) by summing them in some implementations and normalizing them, if necessary. The summation provides a residual connection. Normalization allows output values to not become too large, which allows more layers to be used in the machine learning model.

Feed forward layer 530 typically includes a rectified linear unit (ReLU) layer between two linear layers. The feed forward layer 530 utilizes a multilayer perceptron (MLP) to implement its steps that include feed-forward data movement in hidden layers with no loops. In various implementations, each of the linear layers includes its own set of weights (query weight matrix, key weight matrix, value weight matrix) and performs the steps described for machine learning initial attention stage 300 (of FIG. 3). Therefore, the number of weights can increase considerably, especially when the number of layers increase and the number of encoder blocks and decoder blocks increase. As described earlier, the transformer stage 260 (of FIG. 2) can have any number of encoder blocks 240 and 242 and any number of decoder blocks 250 and 252. In an implementation, there are 6 of each of the encoder blocks and decoder blocks. The inputs to the decoder blocks can originate from the outputs of one or more encoder blocks and one or more decoder blocks. Therefore, the attention techniques are repeated and are based on different layers of the transformer model (or stage or layer). The order of operations and the inputs used for different layers and sub-layers are described in a computational graph such as computational graph 700 (of FIG. 7).

Turning now to FIG. 6, a generalized diagram is shown of processing stages 600 of a transformer of a machine learning model. As shown, processing stages 600 includes transformer front-end stage 650 that receives input vectors 602 and the projection (learnable) weights 604 (or weights 604) and generates output context vectors 660. The transformer front-end stage 650 (or stage 650) includes the similarity function 640, which receives the intermediate states 612 and weighs 604 and generates the output context vectors 660. In various implementations, the input vectors 602 have the format and functionality of input vectors 230 (of FIG. 2), input vectors 306 (of FIG. 3) and input vectors 502 (of FIG. 5). The weights 604 have the format and functionality of weights 962 (of FIG. 2), weight matrices 310, 320 and 330 (of FIG. 3) and weights 504 (of FIG. 5).

During a training phase of the large language model (LLM), multiple initial values of weights and thresholds are input into the LLM, which is executed with multiple iterations until results are determined to be correct above a threshold number of times. The training process is an iterative process that generates a set of weight values used for mapping the input data received to the output results. The weights can be optimized for a particular system architecture of a computing device. In some implementations, the training process utilizes unsupervised learning where input data values are provided with no label (expected result). In other implementations, at least a portion of the training process is supervised and includes labels.

In various implementations, transformer front-end stage 650 includes circuitry that performs the operations illustrated in machine learning initial attention stage 300 (of FIG. 3) and attention layer 400 (of FIG. 4). Matrix multiplication block 610 performs matrix multiplication of input vectors 602 arranged as a matrix and particular matrices of weights 604. In some implementations, matrix multiplication block 610 performs the steps shown in stage 300 (of FIG. 3) to generate the intermediate states 612, which have the format and functionality of the intermediate states shown in stage 300 (of FIG. 3) and attention layer 400 (of FIG. 4). To generate the attention scores 622, the dot product block 620 performs the dot product operation on the key matrix of the intermediate states 612 and the transpose of the key matrix of the intermediate states 612. This is a similar operation performed by operator 422 to generate attention scores 420 (of FIG. 4). Scaling block 624 performs scaling to stabilize the similarity function 640. The multiplication of the matrix elements can lead to very large data values, so the matrix elements are reduced by a scaling factor. In some implementations, the scaling factor is the inverse of the square root of dimension D.

To generate the attention distribution weights 628, the SoftMax function block 626 performs the SoftMax function on the matrix elements of the scaled attention scores from the scaling block 624. This is a similar operation performed by normalization block 550 (of FIG. 4). The matrix multiplication block 630 performs matrix multiplication of the matrix of the attention distribution weights 628 and the values matrix of weights 604. This is a similar operation performed by operator 462 (of FIG. 4). The resulting output context vectors 660 are sent as an output to the next stage of a large language model (LLM) or as the final results of the LLM.

Turning now to FIG. 7, a generalized diagram is shown of a computational graph 700 of a machine learning model. As shown, computational graph 700 includes multiple stages 710-750 that receives the input values 702 and generates the output values 752. The input values 702 have the format and functionality of input values 210 (of FIG. 2) and the output values 752 have the format and functionality of output values 280 (of FIG. 2). Each of the stages 710-750 includes one or more of the blocks and layers 760 and the nodes 780. The computational graph 700 is a graph that visually represents the computational order of operations to perform to implement a machine learning model, the types of operations to perform, and the data dependencies between the operations to perform. In an implementation, the hierarchy of the computational graph 700 has the stages at the highest level followed by blocks and layers and has the nodes at the lowest level. In other implementations, the terms “stage,” “block,” “layer,” and “node” are used differently to represent a different hierarchy. In computational graph 700, the solid arrows represent edges that indicate the data dependencies. The dashed arrows represent possible data dependencies, which are included in one representation of computational graph 700 but not in another implementation.

Although a particular number and type of stages, blocks, layers and nodes are shown, in other implementations, other types of these components and another number of these components are used, and different available versions of the components are possible and contemplated. The stages 710-750 include one or more of the components of the blocks and layers 760 and the nodes 780. In an implementation, some of the states 710-750 include the same functionality and subsets of multiple stages of stages 710-750 include the same functionality. However, different input values and different weights are processed. For example, the stages 710-750 receive corresponding weights of the machine learning weights 760 (or weights 760). The weights 760 are set during a training process.

In some implementations, the blocks and layers 770 include the encoder block 772, the decoder block 774, the feed forward layer 776 and the similarity function 778. In an implementation, these blocks have the same functionality described earlier for similar components of machine learning model 200 (of FIG. 2), the components 500 (of FIG. 5), and processing stages 600 (of FIG. 6). In an implementation, the nodes 780 include the matrix multiplication node 782, the addition and normalization node 784, the SoftMax function node 786, the rectified linear unit (ReLU) node 788, and the linear node 790. Designers construct computational graph 700 to provide the functionality of the desired machine learning model such as at least machine learning model 200 (of FIG. 2).

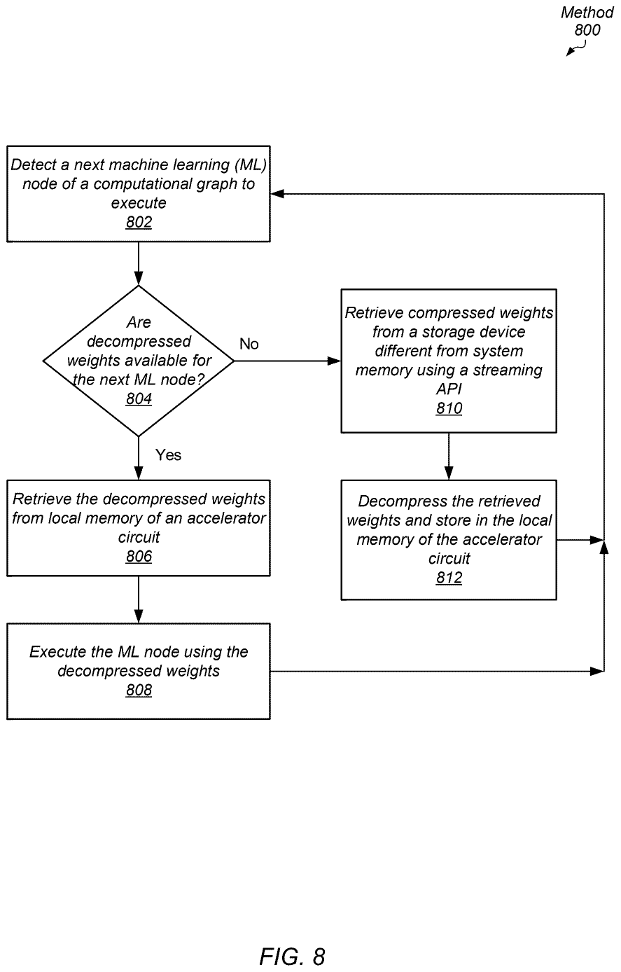

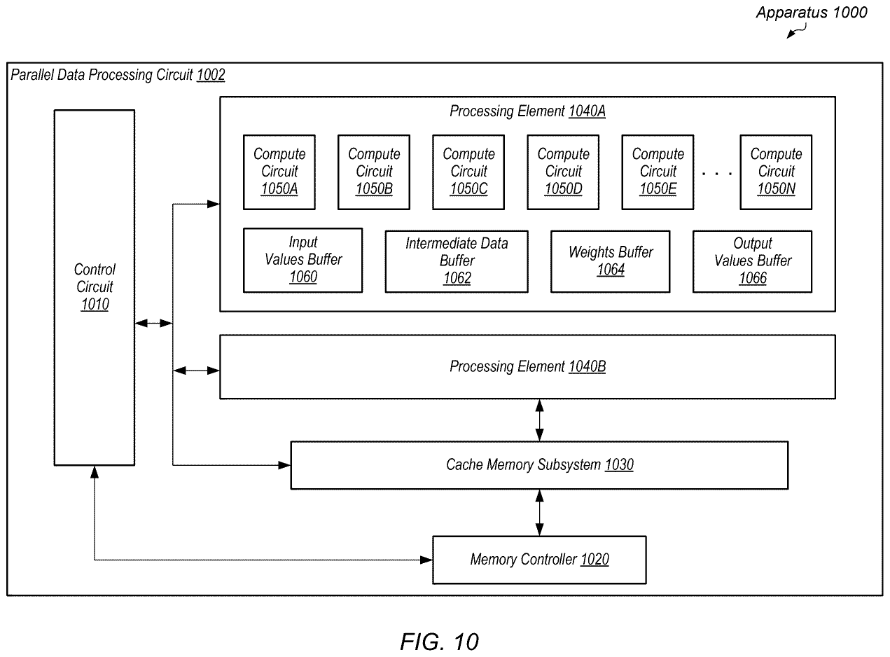

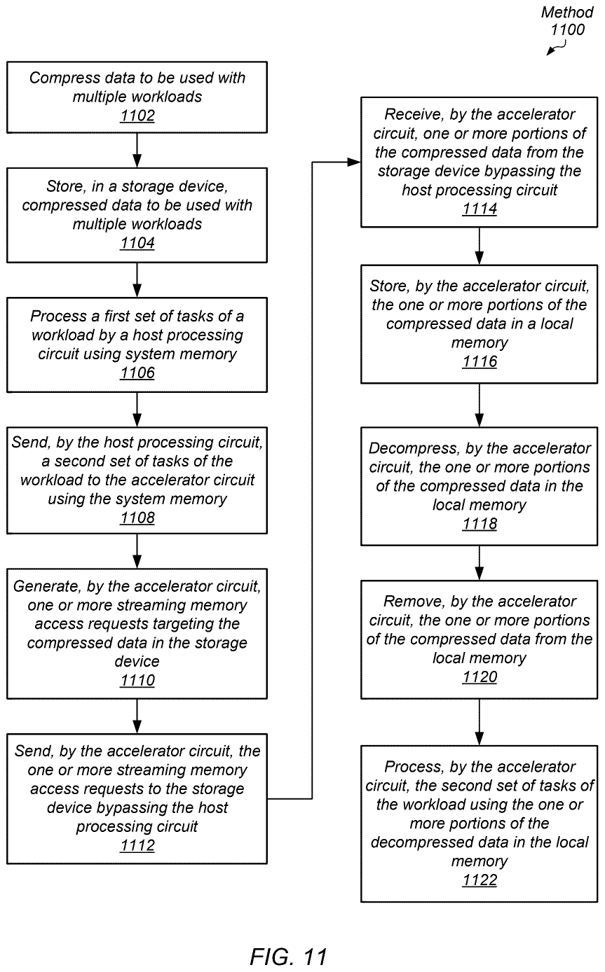

For the methods 800 and 1100 (of FIGS. 8 and 11), a computing system includes multiple processing circuits. Examples of the host processing circuit of the multiple processing circuits are host processing circuit 110 (of FIG. 1) and host processing circuit 922 (of FIG. 9). Examples of the accelerator circuit of the multiple processing circuits are accelerator circuit 130 (of FIG. 1), accelerator circuit 952 (of FIG. 9) and parallel data processing circuit 1002 (of FIG. 10). For the methods 800 and 1100 (of FIGS. 8 and 11), the multiple processing circuits execute a variety of types of parallel data applications such as a variety of types of machine learning (ML) models.

Referring to FIG. 8, a generalized diagram is shown of a method 800 for performing efficient data storage and data transfer of machine learning data. For purposes of discussion, the steps in this implementation are shown in sequential order. However, in other implementations some steps occur in a different order than shown, some steps are performed concurrently, some steps are combined with other steps, and some steps are absent.

The host processing circuit of the computing system executes a machine learning parallel data application. In various implementations, the application is written by a developer in one of a variety of high-level programming languages such as such as C, C++, and Java and so on. In some implementations, the application includes a computational graph such as computational graph 700 (of FIG. 7). The host processing circuit begins processing the application and a library uses a user mode driver (UMD) to translate function calls in the application to commands particular to a piece of hardware such as one of the other processing circuits. In various implementations, this other processing circuit is a parallel data processing circuit, such as an accelerator circuit, and the application utilizes a large language model (LLM). The accelerator circuit detects the next machine learning (ML) node to execute according to a computational order of a computational graph (block 802).

The accelerator circuit verifies whether decompressed weights are available for the next ML node. For example, the accelerator circuit checks local memory for the decompressed weights. If the decompressed weights are available for the next ML node (“yes” branch of the conditional block 804), then the accelerator circuit retrieves the decompressed weights from the local memory of the accelerator circuit (block 806). The accelerator circuit executes the ML node using the decompressed weights (block 808). For example, the accelerator circuit adds the ML node to a work queue (or machine learning queue or scheduler queue) that includes a pointer to the storage location of the local memory that stores the decompressed weights. Afterward, control flow of method 800 returns to block 802 where the accelerator circuit detects the next ML node of the computational graph to execute.

If the decompressed weights are unavailable for the next ML node (“no” branch of the conditional block 804), then the accelerator circuit retrieves compressed weights from a storage device different from system memory using a streaming application programming interface (API) (block 810). The accelerator circuit bypasses the host processing circuit to retrieve the compressed weights from the storage device. In some implementations, the storage device is a non-volatile memory express (NVMe) storage device that utilizes a solid-state disk (SSD) storage capability. The accelerator circuit decompresses the retrieved weights and stores the decompressed weights in the local memory of the accelerator circuit (block 812). Afterward, control flow of method 800 returns to block 802 where the accelerator circuit detects the next ML node of the computational graph to execute.

In various implementations, the accelerator circuit prefetches compressed weights using the streaming memory access requests to transfer compressed weights from the storage device to the local memory of the accelerator circuit without involvement from the host processing circuit or the system memory. Therefore, the conditional block 804 should have the “yes” branch taken more frequently and the latency of executing the ML model is reduced. In an implementation, the next ML node to execute by the accelerator circuit is ML node 5. However, the accelerator circuit has already scheduled and executed streaming memory access requests for compressed weights used by ML nodes 1 to 6. Therefore, the accelerator circuit has preloaded (prefetched) the required compressed weights earlier than when the corresponding ML nodes are ready to execute. When preloading (prefetching) the required compressed weights earlier than when the corresponding ML nodes are ready to execute, in some implementations, the accelerator circuit limits how far ahead to prefetch in order to avoid reaching the data storage capacity of the local memory of the accelerator circuit. Conditions and mechanisms used to enable and disable prefetching of compressed weights from storage device to local memory were described earlier regarding accelerator circuit 130 (of FIG. 1) and points in time t4 and t5.

Turning now to FIG. 9, a generalized diagram is shown of a computing system 900 that performs efficient data storage and data transfer of machine learning data. As shown, computing system 900 includes the processing nodes 910 and 940, system memory 970, local memory 980, switch 990 and memory 992. The hardware, such as circuitry, of each of the first processing node 910 and the second processing node 940 provides a variety of functionalities. For example, the first processing node 910 includes numerous semiconductor dies such as the clients 920 and the second processing node 940 includes the clients 950. As used herein, a “client” refers to an integrated circuit with data processing circuitry and internal memory, which has tasks assigned to it by a scheduler such as an operating system (OS) scheduler or other. Examples of tasks are software threads of a process of an application, which are scheduled by the OS scheduler.

Examples of clients are a general-purpose central processing unit (CPU), a parallel data processing unit with a relatively wide single-instruction-multiple-data (SIMD) microarchitecture, a multimedia integrated circuit, one of a variety of types of an application specific integrated circuit (ASIC), a digital signal processor (DSP), a field programmable gate array (FPGA), one or more microcontrollers, and so forth. Other examples of the parallel data processing circuit are a graphics processing unit (GPU), an embedded inference processing unit (EIPU) or an embedded inference processing circuit, an artificial intelligence (AI) accelerator processing circuit (an accelerator device), a neural processing unit (NPU) or a neural processing circuit, a tensor processing unit (TPU) or a tensor processing circuit, a multiprocessing circuit, and so on. For example, the clients 920 of the processing node 910 include at least the host processing circuit 922, the integrated processing circuit 924, such as an integrated GPU (or iGPU), and the display controller 926. The clients 950 of the processing node 940 includes at least the accelerator circuit 952. Clock sources, such as phase lock loops (PLLs), an interrupt controller, a communication fabric, power controllers, and so forth are not shown in the computing system 900 for ease of illustration. It is also noted that the number of components of the computing system 900 and the number of subcomponents for those shown in FIG. 9, such as within the clients 920 and 950, can vary from implementation to implementation. There can be more or fewer of each component/subcomponent than the number shown for the computing system 900.

In an implementation, the processing node 910 is a system on a chip (SoC) in a semiconductor package on a motherboard and the system memory 970 is one of a variety of types of synchronous random-access memory (SRAM) in a separate semiconductor package on the motherboard. The processing node 910 accesses system memory 970 while processing tasks of a workload. The processing node 910 uses the system memory controller 932 to transfer data with the system memory 970 via a corresponding communication channel that is a point-to-point communication channel. The address information, command information, response data, payload data, header information, and other types of information are transferred on metal traces or wires that are accessible by only the single source and the single destination. In various implementations, processing node 940 uses the system memory controller 962 to transfer data with the system memory 970 via a corresponding communication channel that is also a point-to-point communication channel. In an implementation, the system memory controller 932, the system memory controller 962, and the system memory 970 support one of a variety of types of a Double Data Rate (DDR) communication protocol or one of a variety of types of a Low-Power Double Data Rate (LPDDR) communication protocol.

Secondary storage 972 is a lower level than system memory 970 is the memory hierarchy of computing system 900. Typically, secondary storage 972 is a hard disk drive (HDD) or solid-state drive (SSD) providing non-volatile data storage. The processing node 940 accesses the local memory 980 while processing tasks of a workload. Local memory 980 can be on-chip memory or off-chip memory. In an implementation, the processing node 940 is a system on a chip (SoC) in a semiconductor package on the motherboard and the local memory 980 is one of a variety of types of SRAM in a separate semiconductor package on the motherboard. In another implementation, processing nodes 910 and 940 are located on the same SoC. The processing node 940 uses the local memory controller 964 to transfer data with the local memory 980. In an implementation, the local memory controller 964 supports one of a variety of types of a Graphics Double Data Rate (GDDR) communication protocol.

Between input/output (I/O) controllers 930 and 960, the communication channel transfers data between integrated circuits of the processing nodes 910 and 940. In an implementation, the I/O interfaces 930 and 960 support a communication protocol such as the Peripheral Component Interconnect Express (PCIe) protocol. Similar to other interfaces, such as the system memory controllers 932 and 962 and local memory controller 964, the I/O controllers 930 and 960 include one or more queues for storing requests, responses, and messages, and include circuitry that builds packets for transmission, disassembles packets upon reception, and supports a particular communication protocol. Processing nodes 910 and 940 are also able to access memory 992 via switch 990. In some implementations, I/O controllers 934 and 966, switch 990 and memory 992 support the PCIe protocol. In an implementation, memory 992 is memory of a storage device that is a non-volatile memory express (NVMe) storage device utilizing solid-state disk (SSD) storage. In other implementations, memory 992 is another type of data storage. In some implementations, computing system 900 includes direct memory access interfaces (shown as dashed lines) between local memory 980 and one or more of switch 990 and memory 992. These interfaces support direct data movement for compressed weights 994 from memory 992 directly to local memory 980.

In various implementations, accelerator circuit 952 executes a variety of types of parallel data applications such as machine learning (ML) models. System memory 970 stores instructions describing one or more algorithms of machine learning (ML) model 974 that analyze data to generate one or more predictions or classifications. In various implementations, to generate predictions or classifications, ML model 974 has the functionality of ML model 200 (of FIG. 2), processing stages 600 (of FIG. 6), and computational graph 700 (of FIG. 7). In various implementations, ML model 974 is written by developers in one of a variety of high-level programming languages such as Python, R, Julia, C, C++, C#, and Java and so on. Machine learning libraries can be used with these high-level programming languages to provide predefined modules to aid developers when building the ML application (ML model). Examples of the ML libraries are TensorFlow, Pytorch, Numpy, Keras, Matplotlib, Pandas and so on. A predefined module can be called similar to a function call and the predefined module includes a directed acyclic graph (DAG) providing a sequence of execution steps of a non-recurring computation. The imported ML libraries are used to create computational graphs that provide the computational order of the ML nodes, layers and stages of the ML model. For example, accelerator circuit 952 executes instructions of nodes, layers and stages of ML model 985 in a computational order of computational graph 982. Computational graph 982 has the form of computational graph 700 (of FIG. 7). Here, ML model 985 stored in local memory 980 is a copy of ML model 974 stored in system memory 970. Computational graph 982 stored in local memory 980 is a copy of computational graph 976 stored in system memory 970.

In addition to storing ML model 985, which is a copy of ML model 974, local memory 980 stores decompressed weights 986, which are the decompressed version of the compressed weights 984. Compressed weights 984 are a subset of compressed weights 994 stored in memory 992. One or more of clients 920 and 950 compress machine learning weights (or weights) of a trained ML model such as ML model 974. In an implementation, compression is performed without pruning or quantizing the weights. Therefore, precision of the weights is not reduced when the weights are decompressed. In some implementations, ML model 974 is one of a variety of types of a large language model (LLM). Examples of these LLMs are similar to the examples of LLMs described earlier for ML model 200 (of FIG. 2). Memory 992 stores the compressed weights 994. Host processing circuit 922 begins processing the instructions of the ML model and a library uses a user mode driver (UMD) to translate function calls in the application to commands particular to a piece of hardware such as accelerator circuit 952. The commands are included in at least computational graph 982 stored in local memory 980.

Based on the computational graph 982, accelerator circuit 952 detects a next machine learning (ML) node to execute. Accelerator circuit 952 verifies whether decompressed weights 986 stored in local memory 980 include weights to be used for the next ML node. For example, accelerator circuit 952 checks local memory 980 for the decompressed weights. If the decompressed weights are available for the next ML node, then accelerator circuit 952 retrieves the required decompressed weights from decompressed weights 986 stored in local memory 980. Following, accelerator circuit 952 executes the ML node using the retrieved decompressed weights. For example, accelerator circuit 952 adds the ML node to a work queue (or machine learning queue or scheduler queue) that includes a pointer to the storage location of the local memory 980 that stores the decompressed weights.

If the required decompressed weights are unavailable for the next ML, then accelerator circuit 952 retrieves the required compressed weights from compressed weights 994 in memory 992 different from system memory 970. In an implementation, accelerator circuit 952 adds, in streaming queue 967 (or stream queue 967), a streaming memory access request that targets the required compressed weights. Processing node 940, via I/O controller 966, sends the memory access request to memory 992 via switch 990. I/O controller 966 supports a streaming application programming interface (API) that provides direct access to data stored in memory 992 without involvement from host processing circuit 922 or system memory 970. In some implementations, I/O controller 966 supports Microsoft DirectStorage API for direct memory accesses without involvement from host processing circuit 922, file system APIs and system memory 970. Therefore, no file system API is used. Accordingly, access latency is reduced when compared to computing systems that retrieve weights from system memory 970 and rely on host processing circuit 922 and file system API.

Accelerator circuit 952 decompresses the compressed weights 994 retrieved from memory 992 and stores the decompressed weights as decompressed weights 986 in local memory 980. Therefore, the same device or processing circuit (accelerator circuit 952) both decompresses the retrieved weights and executes the ML operators of the ML nodes, layers and stages that utilize the decompressed weights. Accordingly, no further copies of the decompressed weights besides the decompressed weights 986 stored in local memory 980 are used in computing system 900. The weights are retrieved and decompressed “just-in-time” as the ML model needs them, which provides tight synchronization between storage of required weights and usage of the required weights during execution of the corresponding ML nodes, layers and stages.

Turning now to FIG. 10, a block diagram is shown of an apparatus 1000 that performs efficient data storage and data transfer of machine learning data. In one implementation, apparatus 1000 includes parallel data processing circuit 1002. As shown, parallel data processing circuit 1002 includes control circuit 1010, memory controller 1020, cache memory subsystem 1030 and processing elements 1040A-1040B. Examples of parallel data processing circuit 1002 are the same as examples of accelerator circuit 130 (of FIG. 1) and accelerator circuit 952 (of FIG. 9). In various implementations, parallel data processing circuit 1002 executes a variety of types of parallel data applications such as machine learning (ML) models. For example, parallel data processing circuit 1002 executes instructions of nodes, layers and stages of a ML model in a computational order of a computational graph such as computational graph 700 (of FIG. 7).

Parallel data processing circuit 1002 includes at least control circuit 1010, processing elements 1040A-1040B, cache memory subsystem 1030, and memory controller 1020. Each of processing elements 1040A-1040B includes the multiple compute circuits 1050A-1050N and multiple buffers such as input values buffer 1060, intermediate data buffer 1062, weights buffer 1064 and output values buffer 1066. It should be understood that the components and connections shown for parallel data processing circuit 1002 are merely representative of one type of processing circuit and does not preclude the use of other types of processing circuits for implementing the techniques presented herein.

The apparatus 1000 also includes other components which are not shown to avoid obscuring the figure such as at least a communication fabric, one or more system buses, clock signal generating circuitry, power management circuitry, input/output (I/O) interfaces and so on. In other implementations, the parallel data processing circuit 1002 includes other components, omits one or more of the illustrated components, has multiple instances of a component even if only one instance is shown in the apparatus 1000, and/or is organized in other suitable manners. Also, each connection shown in apparatus 1000 is representative of any number of connections between components. Additionally, other connections can exist between components even if these connections are not explicitly shown in apparatus 1000.

In some implementations, parallel data processing circuit 1002 includes interfaces to one or more memories such as a local memory, system memory and one or more other external storage devices such as storage device 120 (of FIG. 1) and memory 992 (of FIG. 9). Although a single memory controller 1020 is shown, it is possible and contemplated that parallel data processing circuit 1002 includes multiple memory controllers supporting one or more communication protocols with a variety of data storage devices. In an implementation, memory controller 1020 (and any other memory controller) directly communicates with each of the processing elements 1040A-1040B and cache memory subsystem 1030 and includes circuitry for supporting communication protocols and queues for storing requests and responses. As part of executing an application, such as a ML model, a host CPU (not shown) launches kernels to be executed by parallel data processing circuit 1002. Control circuit 1010 receives kernels from the host CPU either directly or via system memory and determines when to dispatch kernels for execution on compute circuits 1050A-1050N of processing elements 1040A-1040B.

Parallel threads executing on compute circuits 1050A-1050N read data from and write data to the cache memory subsystem 1030, vector general-purpose registers, scalar general-purpose registers, and one or more of buffers 1060-1066. In various implementations, the circuitry of processing element 1040B is a replicated instantiation (or silicon integrated circuit copy) of the circuitry of processing element 1040A. In some implementations, each of the processing elements 1040A-1040B is a chiplet. As used herein, a “chiplet” is a semiconductor die (or die) fabricated separately from other dies, and then interconnected with these other dies in a single integrated circuit in the multi-chip module (MCM). On a single silicon wafer, multiple chiplets can be fabricated as multiple instances of particular integrated circuitry. A first silicon wafer (or first wafer) is fabricated with multiple instances of integrated circuitry of a first chiplet, and this first wafer is diced using laser cutting techniques to separate the multiple copies of the first chiplet. A second silicon wafer (or second wafer) is fabricated with multiple instances of integrated circuitry of a second chiplet, and this second wafer is diced using laser cutting techniques to separate the multiple copies of the second chiplet.

In an implementation, each of the multiple compute circuits 1050A-1050N includes one or more vector processing circuits with circuitry of multiple parallel computational lanes of simultaneous execution. These parallel computational lanes operate in lockstep. In various implementations, the data flow within each of the lanes is pipelined. Pipeline registers are used for storing intermediate results and circuitry for arithmetic logic units (ALUs) perform integer arithmetic, floating-point arithmetic, Boolean logic operations, branch condition comparisons and so forth. These components are not shown for ease of illustration. Each of the ALUs within a given row across the lanes includes the same circuitry and functionality, and operates on the same instruction, but different data, such as a different data item, associated with a different thread.

In addition to the multiple vector processing circuits, compute circuits 1050A-1050N also include an assigned number of vector general-purpose registers (VGPRs), an assigned number of scalar general-purpose registers (SGPRs), and an assigned data storage space of one or more of buffers 1060-1066. Schedulers in one or more of control circuit 110, processing elements 1040A-1040B and compute circuits 1050A-1050N receive instructions, such as instructions of stages, layers and nodes of a ML model, and determine when to execute the instructions.

Referring to FIG. 11, a generalized diagram is shown of a method 1100 for performing efficient data storage and data transfer of machine learning data. For purposes of discussion, the steps in this implementation are shown in sequential order. However, in other implementations some steps occur in a different order than shown, some steps are performed concurrently, some steps are combined with other steps, and some steps are absent.

As described earlier for method 800 (of FIG. 8), the host processing circuit of the computing system executes a machine learning parallel data application. The application includes a computational graph such as computational graph 700 (of FIG. 7). One or more of the processing circuits of the computing system compresses data to be used with multiple workloads (block 1102). The processing circuits store, in a storage device, compressed data to be used with multiple workloads (block 1104). In some implementations, the storage device is a non-volatile memory express (NVMe) storage device that utilizes a solid-state disk (SSD) storage capability. The host processing circuit processes a first set of tasks of a workload by a host processing circuit using system memory (block 1106).

The host processing circuit sends a second set of tasks of the workload to the accelerator circuit using the system memory (block 1108). The accelerator circuit generates one or more streaming memory access requests targeting the compressed data in the storage device (block 1110). The accelerator circuit sends one or more streaming memory access requests to the storage device while bypassing the host processing circuit (block 1112). The accelerator circuit receives one or more portions of the compressed data from the storage device while bypassing the host processing circuit (block 1114). The accelerator circuit stores one or more portions of the compressed data in a local memory (block 1116). The accelerator circuit decompresses one or more portions of the compressed data in the local memory (block 1118). The accelerator circuit removes one or more portions of the compressed data from the local memory (block 1120). The accelerator circuit sends processes the second set of tasks of the workload using one or more portions of the decompressed data in the local memory (block 1122).

Turning now to FIG. 12, a generalized diagram is shown of a computing system 1200 that performs efficient data storage and data transfer of machine learning data. As shown, computing system 1200 includes accelerator device 1210 and storage device 1280. A host processing circuit, system memory, secondary storage, clock sources, such as phase lock loops (PLLs), an interrupt controller, a communication fabric, power controllers, and so forth are not shown in the computing system 1200 for ease of illustration. It is also noted that the number of components of the computing system 1200 and the number of subcomponents for those shown in FIG. 12, such as within accelerator device 1210, can vary from implementation to implementation. There can be more or fewer of each component/subcomponent than the number shown for the computing system 1200.

In various implementations, accelerator device 1210 utilizes a relatively wide single-instruction-multiple-data (SIMD) microarchitecture and has the same functionality as accelerator circuit 130 (of FIG. 1), accelerator circuit 952 (of FIG. 9), and parallel data processing circuit 1002 (of FIG. 10). Examples of the accelerator device 1210 are an application specific integrated circuit (ASIC), a digital signal processor (DSP), a field programmable gate array (FPGA), a graphics processing unit (GPU), an embedded inference processing unit (EIPU) or an embedded inference processing circuit, an artificial intelligence (AI) accelerator processing circuit (an accelerator device), a neural processing unit (NPU) or a neural processing circuit, a tensor processing unit (TPU) or a tensor processing circuit, and so on. Accelerator device 1210 includes multiple compute circuits 1220. In various implementations, each of the compute circuits 1220 has the circuitry and functionality of compute circuits 1050A-1050N (of FIG. 10). Accelerator device 1210 also includes local memory shown as distributed memories such as machine learning (ML) operating queue 1230, weights decompression queue 1232 and buffer memory 1240. Although shown separately, in an implementation, each of these memories are corresponding data storage locations of one of a variety of types of a single memory or corresponding data storage locations of a cache memory subsystem.

In an implementation, storage device 1280 is a non-volatile memory express (NVMe) storage device utilizing solid-state disk (SSD) storage. In other implementations, storage device 1280 is another type of data storage. In various implementations, storage device 1280 has the functionality of storage device 120 (of FIG. 1) and memory 992 (of FIG. 9). In various implementations, computing system 1200 includes direct memory access interfaces between weights decompression queue 1232 (or queue 1232) and storage device 1280. This interface supports direct data movement for compressed weights 1282 from storage device 1280 directly to queue 1232. In an implementation, the direct data movement is supported by a PCIe switch, but the direct data movement does not rely on a host processing circuit, file system API or system memory.

In some implementations, accelerator device 1210 supports a streaming application programming interface (API) that provides direct access to data stored in storage device 1280 without involvement from a host processing circuit or system memory. In some implementations, accelerator device 1210 supports Microsoft DirectStorage API for direct memory accesses without involvement from the host processing circuit, file system APIs and the system memory. Therefore, no file system API is used. Accordingly, access latency is reduced when compared to computing systems that retrieve weights 1270 from the system memory and rely on the host processing circuit and file system API.

When scheduled, one or more compute circuits 1220 of accelerator device 1210 decompress the compressed version of weights 1270 retrieved from storage device 1280 via queue 1232 and stores the decompressed version of weights 1270 in buffer memory 1240. Therefore, the same device or processing circuit (accelerator device 1210) both decompresses the retrieved versions of weights 1270 and executes the ML operators of the ML nodes 1260 that are used by the layers and stages 1252-1256 of machine learning (ML) model 1250. In various implementations, to generate predictions or classifications, ML model 1250 has the functionality of ML model 200 (of FIG. 2), processing stages 600 (of FIG. 6), computational graph 700 (of FIG. 7), and ML model 974 (of FIG. 9). When executed by compute circuits 1220, the stages 1252-1256 of ML model 1250 stored in queue 1230 utilize the decompressed weights 1242 stored in buffer memory 1240. Accordingly, no further copies of the decompressed weights besides the decompressed weights 1242 stored in buffer memory 1240 are used in computing system 1200. The weights 1270 are retrieved and decompressed “just-in-time” as the ML model 1250 needs them, which provides tight synchronization between storage of required weights and usage of the required weights during execution of the corresponding stages 1252-1256 of ML model 1250.

It is noted that one or more of the above-described implementations include software. In such implementations, the program instructions that implement the methods and/or mechanisms are conveyed or stored on a computer readable medium. Numerous types of media which are configured to store program instructions are available and include hard disks, floppy disks, CD-ROM, DVD, flash memory, Programmable ROMs (PROM), random access memory (RAM), and various other forms of volatile or non-volatile storage. Generally speaking, a computer accessible storage medium includes any storage media accessible by a computer during use to provide instructions and/or data to the computer. For example, a computer accessible storage medium includes storage media such as magnetic or optical media, e.g., disk (fixed or removable), tape, CD-ROM, or DVD-ROM, CD-R, CD-RW, DVD-R, DVD-RW, or Blu-Ray. Storage media further includes volatile or non-volatile memory media such as RAM (e.g., synchronous dynamic RAM (SDRAM), double data rate (DDR, DDR2, DDR3, etc.) SDRAM, low-power DDR (LPDDR2, etc.) SDRAM, Rambus DRAM (RDRAM), static RAM (SRAM), etc.), ROM, Flash memory, non-volatile memory (e.g., Flash memory) accessible via a peripheral interface such as the Universal Serial Bus (USB) interface, etc. Storage media includes microelectromechanical systems (MEMS), as well as storage media accessible via a communication medium such as a network and/or a wireless link.

Additionally, in various implementations, program instructions include behavioral-level descriptions or register-transfer level (RTL) descriptions of the hardware functionality in a high-level programming language such as C, or a design language (HDL) such as Verilog, VHDL, or database format such as GDS II stream format (GDSII). In some cases, the description is read by a synthesis tool, which synthesizes the description to produce a netlist including a list of gates from a synthesis library. The netlist includes a set of gates, which also represent the functionality of the hardware including the system. The netlist is then placed and routed to produce a data set describing geometric shapes to be applied to masks. The masks are then used in various semiconductor fabrication steps to produce a semiconductor circuit or circuits corresponding to the system. Alternatively, the instructions on the computer accessible storage medium are the netlist (with or without the synthesis library) or the data set, as desired. Additionally, the instructions are utilized for purposes of emulation by a hardware-based type emulator from such vendors as Cadence®, EVE®, and Mentor Graphics®.

Although the implementations above have been described in considerable detail, numerous variations and modifications will become apparent to those skilled in the art once the above disclosure is fully appreciated. It is intended that the following claims be interpreted to embrace all such variations and modifications.

What is claimed is:

1. An apparatus comprising:
a plurality of compute circuits; and
circuitry configured to:
retrieve, from a storage device, a subset of compressed weights that are used in a machine learning model, responsive to having been identified as required for one or more of a plurality of machine learning operations;
decompress the subset of compressed weights to create decompressed weights;
store the decompressed weights in a local memory of the apparatus; and
cause the one or more of the plurality of machine learning operations to be executed by one or more of the plurality of compute circuits using the decompressed weights.

2. The apparatus as recited in claim 1, wherein the circuitry is configured to directly access the storage device while bypassing a host processing circuit when retrieving the subset of the compressed weights from the storage device.

3. The apparatus as recited in claim 2, wherein to directly access the storage device, the circuitry is configured to utilize a data storage application programming interface (API) that supports streaming queues storing memory access requests.

4. The apparatus as recited in claim 1, wherein the plurality of compute circuits are configured to execute a plurality of nodes of the machine learning model in an order specified by a computational graph.

5. The apparatus as recited in claim 4, wherein the machine learning model is a large language model.

6. The apparatus as recited in claim 4, wherein the circuitry is configured to schedule retrieval of compressed weights from the storage device prior to corresponding nodes of the plurality of nodes that use the compressed weights being scheduled for execution.

7. The apparatus as recited in claim 6, wherein the circuitry is configured to issue a node of the plurality of nodes to a compute circuit of the plurality of compute circuits, responsive to compressed weights of the node having been stored in the local memory.

8. A method, comprising:
retrieving from a storage device, by circuitry of an accelerator device, a subset of compressed weights that are used in a machine learning model, responsive to having been identified as required for one or more of a plurality of machine learning operations;
decompressing, by the circuitry, the subset of compressed weights to create decompressed weights;
storing, by the circuitry, the decompressed weights in a local memory; and
causing, by the circuitry, the one or more of the plurality of machine learning operations to be executed using the decompressed weights by one or more of a plurality of compute circuits of the accelerator device.

9. The method as recited in claim 8, further comprising directly accessing, by the circuitry, the storage device while bypassing a host processing circuit and a corresponding system memory when retrieving the subset of the compressed weights from the storage device.

10. The method as recited in claim 9, wherein to directly access the storage device, the method further comprises utilizing, by the circuitry, a data storage application programming interface (API) that supports streaming queues storing memory access requests.

11. The method as recited in claim 8, further comprising executing, by the plurality of compute circuits, a plurality of nodes of the machine learning model in a computation order specified by a computational graph.

12. The method as recited in claim 11, wherein the machine learning model is a large language model (LLM).

13. The method as recited in claim 11, further comprising scheduling, by the circuitry, retrieval of compressed weights from the storage device prior to corresponding nodes of the plurality of nodes that use the compressed weights become next nodes to schedule for execution.

14. The method as recited in claim 13, further comprising issuing, by the circuitry, a node of the plurality of nodes to a compute circuit of the plurality of compute circuits, responsive to compressed weights of the node have been stored in the local memory.

15. A computing system comprising:
a host processing circuit configured to translate instructions of a machine learning model to commands that perform a plurality of machine learning operations;
a storage device comprising circuitry configured to store a plurality of compressed weights that are used in the machine learning model; and
an accelerator device comprising circuitry configured to:
retrieve, from the storage device, a subset of the plurality of compressed weights, responsive to having been identified as required for one or more of the plurality of machine learning operations;
decompress the subset of compressed weights to create decompressed weights;
store the decompressed weights in a local memory of the accelerator device; and
cause the one or more of the plurality of machine learning operations to be executed by one or more of a plurality of compute circuits using the decompressed weights.

16. The computing system as recited in claim 15, wherein the circuitry is configured to directly access the storage device and bypass the host processing circuit and corresponding system memory when retrieving the subset of the compressed weights from the storage device.

17. The computing system as recited in claim 16, wherein to directly access the storage device, the circuitry is configured to utilize a data storage application programming interface (API) that supports streaming queues storing memory access requests.

18. The computing system as recited in claim 15, wherein the plurality of compute circuits is configured to execute a plurality of nodes of the machine learning model in a computation order specified by a computational graph.

19. The computing system as recited in claim 18, wherein the machine learning model is a large language model (LLM).

20. The computing system as recited in claim 18, wherein the circuitry is configured to schedule retrieval of the subset of compressed weights from the storage device prior to corresponding nodes of the plurality of nodes that use the subset of compressed weights become next nodes to schedule for execution.
